(19) United States
(12) Patent Application Publication
(10) Pub. No.: US 2003/0052160 A1
(43) Pub. Date: Mar. 20, 2003

(54) Use for ATMs as voting machines

(76) Inventor: Marvin Joseph Glover, New York, NY (US)

Correspondence Address: Marvin Glover, 500 East 77 St Apt# 439, New York, NY, 10162, US

(21) Appl. No.: 09/951,824

(22) Filed: Sep. 14, 2001

(51) Int. Cl. G06F 17/00; G06K 5/00

(52) U.S. Cl. 235/375

(57) ABSTRACT

Automated Teller Machines are ideal electronic voting machines. They are secure, easy to operate, accessible, well maintained, and inexpensive to use. During elections, a pre-certified voter's identification card would activate the ATM in the same way as a bank or credit card, calling up an electronic ballot, on the screen.

### DESCRIPTION

### BACKGROUND OF THE INVENTION

1. Field of Invention

The present invention relates to electronic data processing systems such as are commonly found in voting and in electronic banking.

2. Description of the Related Art

The outcome of the recent, hotly disputed U.S. presidential election, pitting Al Gore against George Bush jr., is undeniable proof that current voting practices are incapable of determining the winner of a close election. Even knowing how inadequate the system is, and how dissatisfied everyone is with it, no one expects it to change. That's because the cost of replacing all the antiquated paper ballot voting machines with modem electronic voting machines, is prohibitively expensive. That financial burden is even more prohibitive in many other countries not as financially well off as the United States.

Current Voting Costs Include:

1. Purchasing voting machines.

2. Storing voting machines when they are not in use.

3. Transporting voting machines to and from voting sites during elections.

4. Maintenance costs. Currently, voting machines must endure long periods of inactivity, in storage facilities that are often uncontrolled temperature and humidity environments. They must also endure rough handling while being transported to and from the voting stations. All this means that maintenance costs are inevitably high. Modem electronic voting machines are at even greater risk than traditional punch-card based voting machines, plus their initial cost and repair costs tend to be much greater.

There are also emotional costs to the voter, under the current system. These emotional costs are reflected in the low voter turn-out seen during elections. These include:

5. The discomfort and inconvenience of having to go someplace unfamiliar in order to vote, and possibly getting lost.

6. The embarrassment of having to throw your paper ballot away and request a new one, when you make a mistake.

7. Having to vote under a cloud of scandalous reports of voting irregularities, such as ballot box stuffing, which are endemic to antiquated paper ballot systems.

### SUMMARY OF THE INVENTION

This invention makes voting easy, accurate and affordable.

ATMs are used by people in their everyday activities, so they're whereabouts are known, and people are comfortable using them.

Mistakes made on ATMs are easily corrected without drawing attention to one's self

The high security of the ATMs, and of the data processing done by the banking system, virtually eliminates voter's concerns over fraudulent elections.

Other advantages of ATMs include:

They're accessible to handicapped persons, due to their many curbside locations.

Because ATMs are on an international data processing system, people who are out of the country can use foreign ATMs to vote, instead of cumbersome mail-in ballots.

ATMs are rapidly evolving, becoming ever more user friendly. They offer many different language options and some offer spoken, as well as written options.

Because ATMs are set up to print receipts, the voter has the reassuring option of receiving a printed copy of his vote.

Because the ATMs would be used very infrequently as voting machines, harm to the hosting ATM establishments would be minimal. That harm would be compensated by the good will their patriotic service generates in their clientele, as well as by the free advertising it affords the hosting ATM establishments. In the worst case scenario in which all of the hosting ATM establishments demand full fair financial compensation, it would still cost far less than the cost of purchasing, storing, moving and maintaining our current, woefully inadequate voting system.

ATMs are now an integral part of the banking system, so they don't have to be purchased, moved or stored. Their alternate use as voting machines is mandated by national security concerns under society's legal right of Eminent Domain.

### DETAILED DESCRIPTION OF PREFERRED EMBODIMENT

In the preferred embodiment for enabling ATM voting, in accordance with the present invention, voters undergo a registration process, in order to become qualified to vote in an upcoming election. Registered voters are each issued an individual “smart card”. Each smart card includes the voter identification, his or her precinct, a ballot ID for the particular precinct assigned to the voter, and a PIN number for the smart card, which provides a personal identification associated with that particular voter.

The card is inserted in the magnetic card reader of the ATM and the PIN number entered. Before a ballot is displayed, the PIN entered by the voter must match the PIN carried by the smart card and read by the magnetic card reader.

All the information contained in the smart cards is passed by the AT555M to an authentication server. The authentication server interacts with a journal server that in turn interacts with the result server.

In accordance with the preferred embodiment of the present invention, one or more cryptographic operations are utilized to encrypt data flowing between the ATMs and the servers.

What I claim as my invention is:

1. An improved system of electronic voting, comprising:
(a) Automated Teller Machines, (b) machine readable voter identification cards, and (c) data processing infrastructure.
While the invention has been particularly described with reference to a preferred embodiment, it will be understood by those skilled in the art that various changes in form and detail may be made therein without departing from the spirit and scope of the invention.
